(19) United States
(12) Patent Application Publication
(10) Pub. No.: US 2018/0367905 A1
(43) Pub. Date: Dec. 20, 2018

(54) Vibration Diaphragm and MEMS Microphone Using Same

(71) Applicant: AAC ACOUSTIC TECHNOLOGIES (SHENZHEN) CO., LTD, Shenzhen (CN)

(72) Inventors: Zhenkui Meng, Shenzhen (CN); Zhijiang Wu, Shenzhen (CN)

(21) Appl. No.: 15/871,257

(22) Filed: Jan. 15, 2018

(30) Foreign Application Priority Data
Jun. 19, 2017 (CN) 201720710459.X

(51) Int. Cl. H04R 7/04; H04R 19/04

(52) U.S. Cl. CPC H04R 7/04; H04R 2201/003; H04R 19/04

(57) ABSTRACT

The present disclosure provides a vibration diaphragm for a MEMS microphone. The vibration diaphragm includes a first sound hole group disposed at an edge of the vibration diaphragm; a second sound hole group disposed around the first sound hole group; and a third sound hole group disposed around the second sound hole group. Any three adjacent sound holes selected from the first and second sound hole groups form an isosceles triangle. By the arrangement of the sound holes, the vibration diaphragm in the MEMS microphone can not only ventilate air, but also release the stress efficiently, in order to obtain better acoustic performance.

### CROSS-REFERENCE TO RELATED APPLICATIONS

This application claims the priority benefit of Chinese Patent Application Ser. No. 201720710459.X filed on Jun. 19, 2017, the entire content of which is incorporated herein by reference.

### FIELD OF THE PRESENT DISCLOSURE

The present disclosure relates to electro-acoustic transducers, more particularly to a vibration diaphragm of a MEMS microphone.

### DESCRIPTION OF RELATED ART

With the development of wireless communication, a user raises higher and higher requirement to the communication quality of a mobile phone, as a kind of voice pickup device of the mobile phone, the design of the microphone directly impacts the communication quality of the mobile phone.

Currently, a MEMS microphone is extensively applied for the mobile phone. A related MEMS microphone comprises a base, a capacitance system composed of a vibration diaphragm and a back plate keeping a distance from the vibration diaphragm for forming a capacitor. The vibration diaphragm is vibrating under the action of the sound wave, which changes the distance between the vibration diaphragm and the back plate, and then changes the capacitance of the capacitance system, in order to transfer the signal of sound wave into the electric signal. However, since the vibration diaphragm is stretched and contracted while vibrating, it is difficult to release the stress on the vibration diaphragm, which makes the force imposed on the vibration diaphragm imbalanced, and causes the acoustic performance of the MEMS microphone lower.

Therefore it is necessary to provide an improved vibration diaphragm for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative top view of a vibration diaphragm used for a MEMS microphone in accordance with an exemplary embodiment of the present disclosure.

### DETAILED DESCRIPTION OF THE EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the FIGURE and the embodiment. It should be understood the specific embodiment described hereby is only to explain the disclosure, not intended to limit the disclosure.

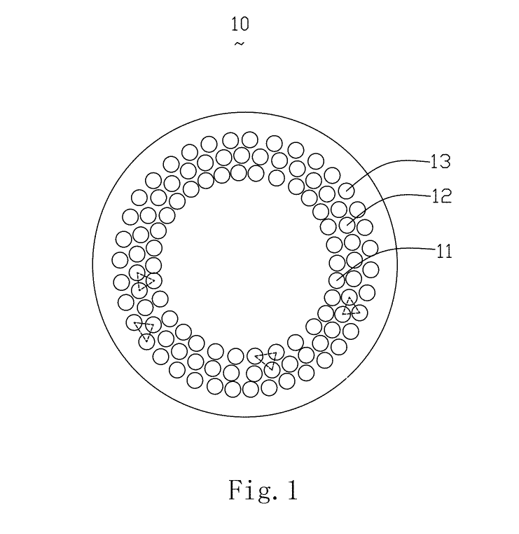

As shown in FIG. 1, a vibration diaphragm 10 includes a first sound hole group 11 disposed at an edge thereof, a second sound hole group 12 disposed around the first sound hole group 11 and a third sound hole group 13 disposed around the second sound hole group 12. A circle formed by connecting centers of the sound holes of the first sound hole group 11 is concentric with a circle formed by connecting centers of the sound holes of the second sound hole group 12; and a circle formed by connecting centers of the sound holes of second sound hole group 12 is concentric with a circle formed by connecting centers of the sound holes of the third sound hole group 13. The first sound hole group 11 can be used as a ventilation hole, and the second sound hole group 12 and the third sound hole group 13 can be used for releasing stress of the vibration diaphragm, certainly, the first sound hole group 11 and the second sound hole group 12 can be used for relieving stress of the vibration diaphragm, and the third sound hole group 13 can be used as the ventilation hole.

Any three adjacent sound holes selected from the first and second sound hole groups 11, 12 form an isosceles triangle, preferably, an equilateral triangle. And, any three sound holes selected from the second sound hole group 12 and the third sound hole group 13 form an isosceles triangle, preferably, an equilateral triangle.

In addition, a diameter of the sound hole of the first sound hole group 11 is equal to a diameter of the sound hole of the second sound hole group 12, and, the diameter of the sound hole of the first sound hole group 11 is equal to a diameter of the sound hole of the third sound hole group 13. The amount and size of the sound holes can be adjusted as the case may be, in order to optimize the performance of the vibration diaphragm.

Further, the present disclosure discloses a MEMS microphone including the vibration diaphragm as described above.

By the arrangement of the sound holes, the vibration diaphragm in the MEMS microphone can not only ventilate air, but also release the stress efficiently, in order to obtain better acoustic performance.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration diaphragm for a MEMS microphone, including:
a first sound hole group disposed at an edge of the vibration diaphragm;
a second sound hole group disposed around the first sound hole group;
a third sound hole group disposed around the second sound hole group;
any three adjacent sound holes selected from the first and second sound hole groups form an isosceles triangle.

2. The vibration diaphragm as described in claim 1, wherein any three adjacent sound holes selected from the third and second sound hole groups form an isosceles triangle.

3. The vibration diaphragm as described in claim 1, wherein the three adjacent sound holes selected from the first and second sound hole groups form an equilateral triangle.

4. The vibration diaphragm as described in claim 2, wherein the three adjacent sound holes selected from the third and second sound hole groups form an equilateral triangle.

5. The vibration diaphragm as described in claim 1, wherein a circle formed by connecting centers of sound holes of the first sound hole group is concentric with a circle formed by connecting centers of sound holes of the second sound hole group.

6. The vibration diaphragm as described in claim 5, wherein a circle formed by connecting centers of sound holes of the third sound hole group is concentric with a circle formed by connecting centers of sound holes of the second sound hole group.

7. The vibration diaphragm as described in claim 1, wherein a diameter of each sound hole of the first sound hole group is equal to a diameter of each sound hole of the second sound hole group.

8. The vibration diaphragm as described in claim 7, wherein a diameter of each sound hole of the third sound hole group is equal to a diameter of each sound hole of the second sound hole group.
